(19) United States
(12) Patent Application Publication
(10) Pub. No.: US 2026/0332943 A1
(43) Pub. Date: Oct. 22, 2026

(54) PORTABLE ELECTRONIC DEVICES AND SPEAKER MODULE

(71) Applicant: Acer Incorporated, New Taipei City (TW)

(72) Inventors: Feng-Ming LIU, New Taipei City (TW); Jia-Ren CHANG, New Taipei City (TW); Chien-Chung CHEN, New Taipei City (TW)

(21) Appl. No.: 19/299,566

(22) Filed: Aug. 14, 2025

(30) Foreign Application Priority Data
Apr. 17, 2025 (TW) 114114572

(51) Int. Cl. H04R 1/28; H04R 1/02

(52) U.S. Cl. CPC H04R 1/2888; H04R 1/028; H04R 1/2873; H04R 1/2896; H04R 1/288

(57) ABSTRACT

A speaker module includes a casing, a first speaker assembly, a second speaker assembly, a third speaker assembly and a guiding assembly. The casing is disposed in a housing of a portable electronic device, and the housing has a first sound opening and a second sound opening. The first speaker assembly is disposed on the casing and is configured to emit a first sound. The second speaker assembly is disposed on the casing, corresponds to the first sound opening, and is configured to emit a second sound. The third speaker assembly is disposed on the casing, corresponds to the second sound opening, and is configured to emit a third sound. The guiding assembly is disposed on the casing. The first speaker assembly is symmetrical to the second speaker assembly, and the guiding assembly is configured to guide a portion of the first sound to the second sound opening.

### CROSS REFERENCE TO RELATED APPLICATIONS

This application claims the benefit of Taiwan Patent Application No. 114114572, filed on Apr. 17, 2025, the entirety of which is incorporated by reference herein.

### TECHNICAL FIELD

The present disclosure relates to a speaker module and a portable electronic device, and more particularly it relates to a speaker module and a portable electronic device capable of eliminating vibration and improving the output effect at the same time. cl BACKGROUND

As technology has developed, many of today's electronic devices (such as notebook computers) have become quite popular products. These notebook computers are among the most popular and widespread of today's consumer products. Users can execute various applications on their notebook computers to achieve various purposes, such as watching videos, playing games, browsing the web, and reading e-books.

Generally speaking, electronic devices such as notebook computers are equipped with at least one speaker module configured to provide sound, such as music. However, existing speaker modules generate unnecessary vibration when emitting sound, and these vibrations may result in contact with the housing of the notebook computer, causing noise and consequently affecting the sound performance of the speaker module.

Therefore, how to design a speaker module that can avoid unnecessary vibrations is a topic that needs to be discussed.

### BRIEF SUMMARY

Accordingly, one objective of the present disclosure is to provide a speaker module to solve the above problems.

According to some embodiments of the disclosure, a speaker module includes a casing, a first speaker assembly, a second speaker assembly, a third speaker assembly, and a guiding assembly. The casing is disposed in the housing of a portable electronic device, and the housing has a first sound opening and a second sound opening. The first speaker assembly is disposed on the casing and configured to emit a first sound. The second speaker assembly is disposed on the casing, corresponds to the first sound opening and is configured to emit a second sound. The third speaker assembly is disposed on the casing, corresponds to the second sound opening and is configured to emit a third sound. The guiding assembly is disposed on the casing. The first speaker assembly is symmetrical to the second speaker assembly, and the guiding assembly is configured to guide a portion of the first sound to the second sound opening.

According to some embodiments, the first speaker assembly and the second speaker assembly are arranged along a first axis, and the casing has a first sound outlet and a second sound outlet, respectively corresponding to the first speaker assembly and the second speaker assembly, wherein when viewed along the first axis, the first sound outlet and the second sound outlet have a rectangular structure.

According to some embodiments, the guiding assembly has a first guiding element and a second guiding element, when viewed along the first axis, the first guiding element is configured to surround two sides of the first sound outlet, and when viewed along the first axis, the second guiding element is configured to surround three sides of the second sound outlet.

According to some embodiments, the casing has a first sub-casing and a second sub-casing, the second sub-casing is configured to be fixedly connected to the first sub-casing, and the first guiding element has a first guiding portion and a second guiding portion which are disposed on the first sub-casing and configured to form a first channel with the first sub-casing.

According to some embodiments, the first guiding portion has a first segment and a second segment, the second guiding portion has a third segment and a fourth segment, the first segment and the third segment extend along a second axis, and the second segment and the fourth segment extend along a third axis, wherein the first axis, the second axis and the third axis are perpendicular to each other.

According to some embodiments, the first guiding portion has a first segment and a second segment, the second guiding portion has a third segment and a fourth segment, the first segment and the third segment extend along a second axis, the fourth segment extends along a third axis, and the second segment is not parallel to the second axis and the third axis, wherein the first axis, the second axis and the third axis are perpendicular to each other.

According to some embodiments, the second guiding element is configured to form a second channel which communicates with the first channel, the second guiding element has a third guiding portion, and when viewed along the first axis, the third guiding portion has a U-shaped structure.

According to some embodiments, the second guiding element further includes a first side segment and a second side segment which extend along the first axis, and the third guiding portion is connected to the first segment and the third segment by the first side segment and the second side segment.

According to some embodiments, the guiding assembly further includes a third guiding element configured to form a third channel which communicates with the first channel, the third guiding element includes a fourth guiding portion, and when viewed along the first axis, the fourth guiding portion has a U-shaped structure.

According to some embodiments, the third guiding element further includes a third side segment and a fourth side segment which extend along the first axis, and the fourth guiding portion is connected to the fourth segment and the second segment by the third side segment and the fourth side segment.

According to some embodiments, the guiding assembly further includes a fourth guiding element configured to be connected to the first guiding element, and the fourth guiding element is configured to cover the first channel and the first speaker assembly.

According to some embodiments, the first guiding element, the second guiding element, and the third guiding element are integrally formed as one piece.

According to some embodiments, the casing, the first guiding element, the second guiding element, and the third guiding element are integrally formed as one piece.

According to some embodiments, the speaker module further includes a separating inner wall which is configured to separate the casing into a first sound cavity and a second sound cavity, the first sound cavity corresponds to the first speaker assembly and the second speaker assembly, and the second sound cavity corresponds to the third speaker assembly.

According to some embodiments, a first opening is formed on a first wall of the separating inner wall, and the speaker module further includes a first one-way air venting element which is disposed on the separating inner wall and covers the first opening, wherein the area of the first opening is 40% to 50% of the total area of the first wall.

According to some embodiments, the first one-way air venting element allows the airflow from the first sound cavity to pass through the first one-way air venting element to enter the second sound cavity, and the first one-way air venting element blocks another airflow from the second sound cavity to pass through the first one-way air venting element to enter the first sound cavity.

According to some embodiments, the separating inner wall further has a second wall, and a second opening is formed on the second wall, and the speaker module further has a second one-way air venting element which is disposed on the second wall and covers the second opening.

According to some embodiments of the disclosure, the present application provides a portable electronic device including a housing, a speaker module and a guiding assembly. The housing has a top cover and a bottom cover, and the bottom cover is connected to the top cover and has a first sound opening and a second sound opening. The speaker module is disposed between the top cover and the bottom cover, and the speaker module includes a casing, a first speaker assembly, a first speaker assembly and a third speaker assembly. The first speaker assembly is disposed on the casing and configured to emit a first sound. The second speaker assembly is disposed on the casing, corresponds to the first sound opening and is configured to emit a second sound. The third speaker assembly is disposed on the casing, corresponds to the second sound opening and is configured to emit a third sound. The guiding assembly is disposed on the casing. The guiding assembly is configured to guide a portion of the first sound to the second sound opening.

According to some embodiments, the guiding assembly includes a first guiding element, a second guiding element and a third guiding element which respectively correspond to the first speaker assembly, the second speaker assembly, and the third speaker assembly and respectively form a first channel, a second channel, and a third channel.

According to some embodiments, the second channel communicates with the first channel, and the third channel communicates with the first channel, wherein the first guiding element and the top cover are integrally formed as one piece.

The present disclosure provides a speaker module, which is disposed in a portable electronic device. The speaker module includes a first speaker assembly, a second speaker assembly, and a third speaker assembly, and the housing of the portable electronic device has a first sound opening and a second sound opening. The first speaker assembly faces the top cover of the housing, the second speaker assembly faces the first sound opening, and the third speaker assembly faces the second sound opening.

In the present disclosure, the top cover does not provide any opening for the first speaker assembly, so that the speaker module may further include a guiding assembly which is configured to guide a portion of the first sound emitted by the first speaker assembly to be output through the second sound opening, and the other portion of the first sound is still output through the first sound opening. Based on such a configuration, the problem of unnecessary vibration generated by the top cover can be avoided

In addition, the speaker module may further include a separating inner wall which is configured to separate the casing into a first sound cavity and a second sound cavity. The separating inner wall may form at least one first opening, and the speaker module may further include a first one-way air venting element which is disposed on the separating inner wall and covers the first opening. Based on such a configuration, the volume of the cavity provided to the first speaker assembly and the second speaker assembly can be increased, thereby improving the overall low frequency sound output effect.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a portable electronic device 10 according to an embodiment of the present disclosure;

FIG. 2 is a schematic diagram of the portable electronic device 10 in another view according to an embodiment of the present disclosure;

FIG. 3 is a stereoscopic schematic diagram of the speaker module 100 according to an embodiment of the present disclosure;

FIG. 4 is a stereoscopic schematic diagram of the speaker module 100 in another view according to an embodiment of the present disclosure;

FIG. 5 is a stereoscopic cross-sectional diagram of the portable electronic device 10 along the line segment A-A in FIG. 1 according to an embodiment of the present disclosure;

FIG. 6 is a cross-sectional view of the portable electronic device 10 along the line segment B-B in FIG. 1 according to an embodiment of the present disclosure;

FIG. 7 is a stereoscopic enlarged diagram of the speaker module 100 in another view according to an embodiment of the present disclosure;

FIG. 8 is a stereoscopic diagram of the speaker module 100 according to another embodiment of the present disclosure;

FIG. 9 is a stereoscopic diagram of a partial structure of the speaker module 100 according to an embodiment of the present disclosure;

FIG. 10 shows the relationship diagram between the abnormal noise and the frequency of the speaker module 100 according to an embodiment of the present disclosure and a conventional speaker without the guiding assembly 200;

FIG. 11 is an energy analysis curve diagram of a conventional speaker module;

FIG. 12 is an energy analysis curve diagram of the speaker module 100 according to an embodiment of the present disclosure;

FIG. 13 is a sound field analysis diagram of the speaker module 100 according to an embodiment of the present disclosure and a conventional speaker module; and

FIG. 14 shows a relationship diagram between frequency and sound pressure level of the speaker module 100 according to an embodiment of the present disclosure and two conventional speaker modules.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

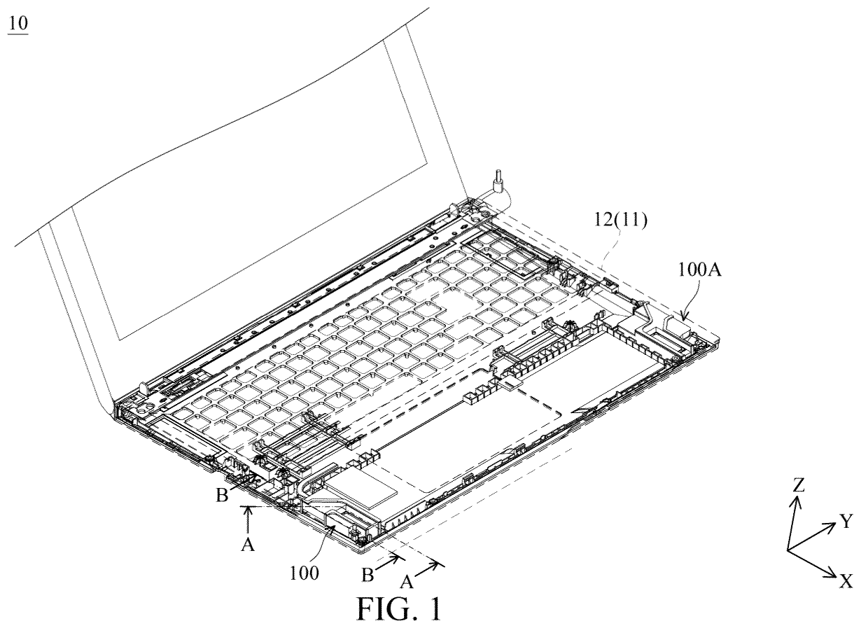

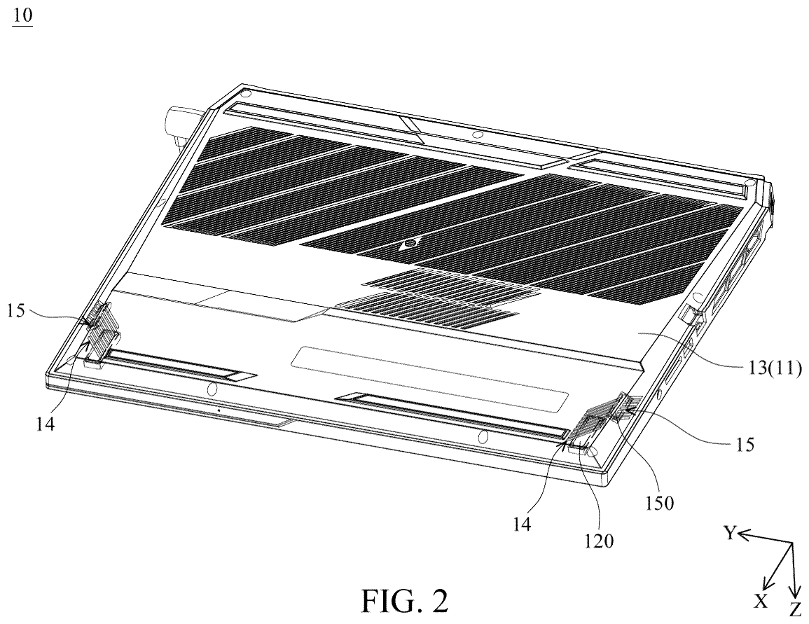

Please refer to FIG. 1 and FIG. 2. FIG. 1 is a schematic diagram of a portable electronic device 10 according to an embodiment of the present disclosure, and FIG. 2 is a schematic diagram of the portable electronic device 10 in another view according to an embodiment of the present disclosure. The portable electronic device 10 includes a housing 11, and a speaker module 100 and a speaker module 100A may be disposed in the housing 11, which are respectively located on two sides of the housing 11 and have the same or similar configurations, so that only the speaker module 100 is described in the following paragraphs.

As shown in FIG. 1 and FIG. 2, the housing 11 has a top cover 12 and a bottom cover 13, and the bottom cover 13 is fixedly connected to the top cover 12 and has two first sound openings 14 and two second sound openings 15. The speaker module 100 is disposed between the top cover 12 and the bottom cover 13, and the sound emitted by the speaker module 100 is output to the user through the corresponding first sound opening 14 and second sound opening 15.

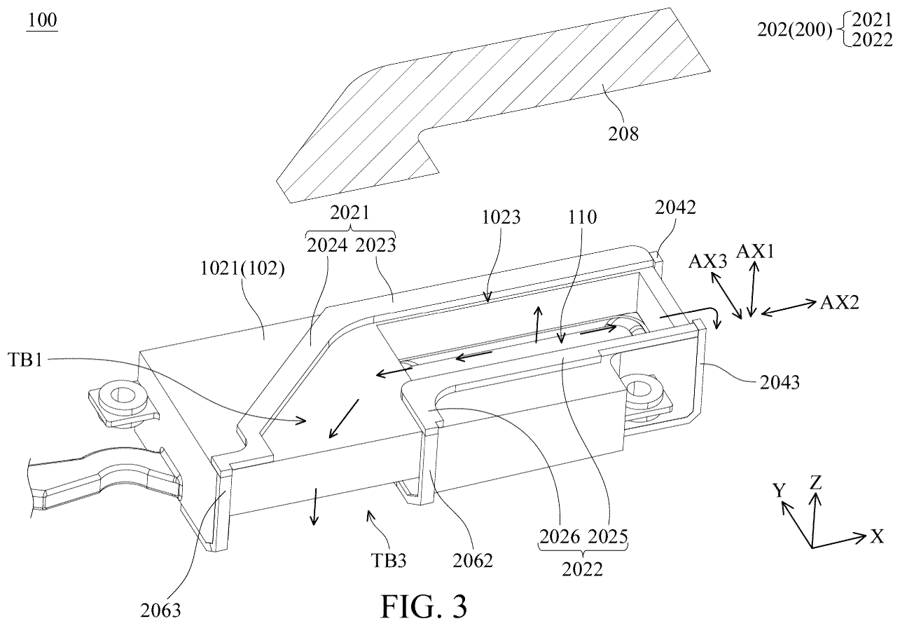

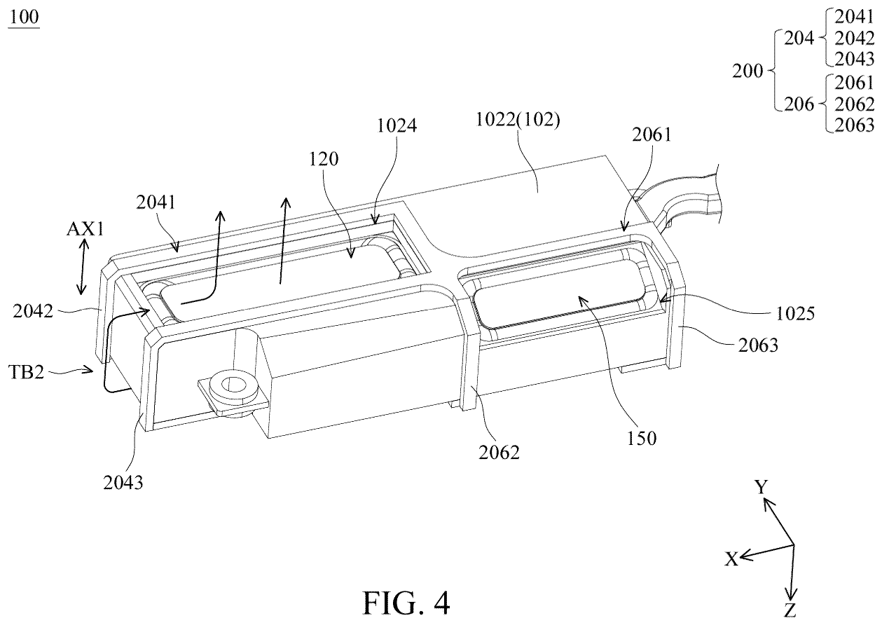

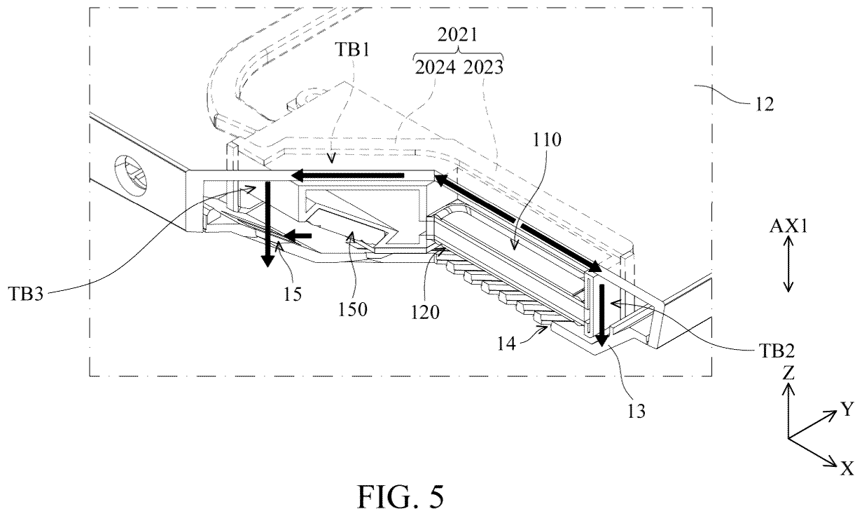

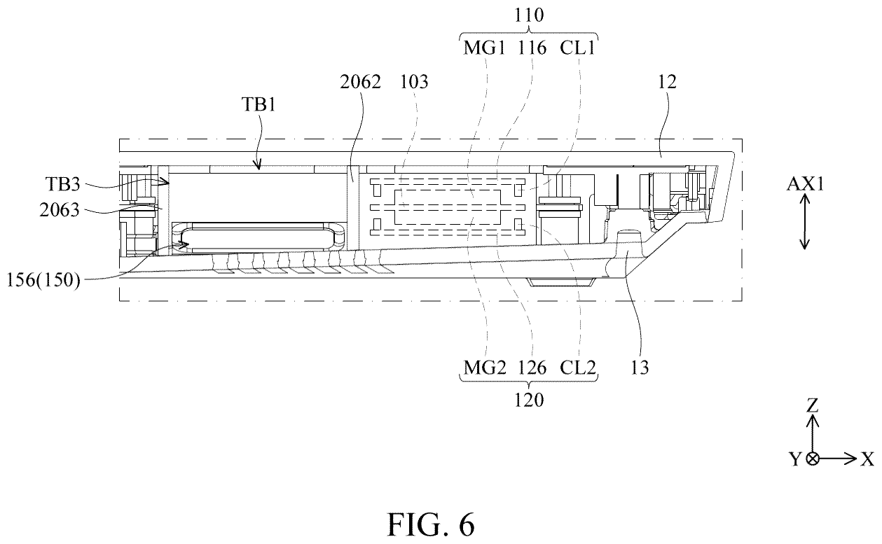

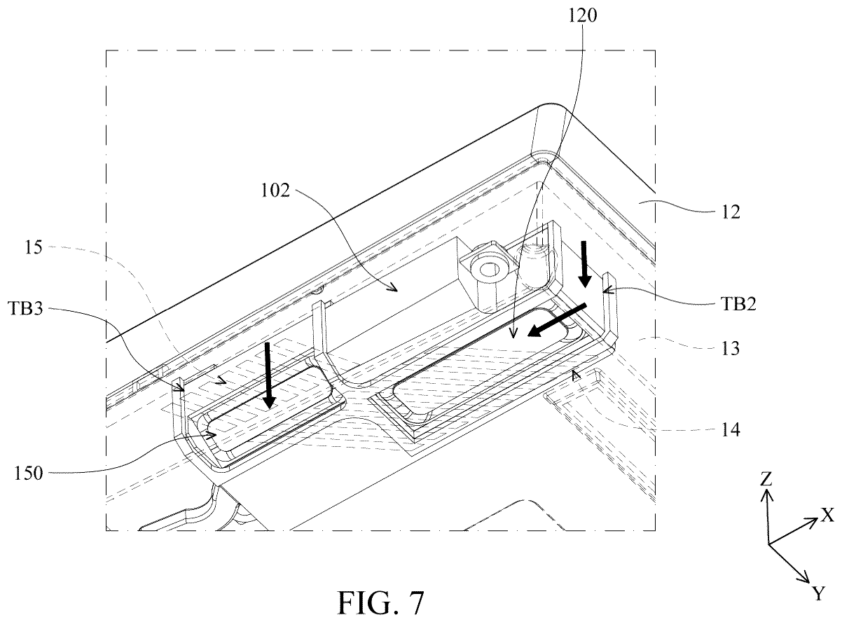

Next, please refer to FIG. 3 to FIG. 7. FIG. 3 is a stereoscopic schematic diagram of the speaker module 100 according to an embodiment of the present disclosure, FIG. 4 is a stereoscopic schematic diagram of the speaker module 100 in another view according to an embodiment of the present disclosure, FIG. 5 is a stereoscopic cross-sectional diagram of the portable electronic device 10 along the line segment A-A in FIG. 1 according to an embodiment of the present disclosure, FIG. 6 is a cross-sectional view of the portable electronic device 10 along the line segment B-B in FIG. 1 according to an embodiment of the present disclosure, and FIG. 7 is a stereoscopic enlarged diagram of the speaker module 100 in another view according to an embodiment of the present disclosure.

The speaker module 100 may include a casing 102, a first speaker assembly 110, a second speaker assembly 120, and a third speaker assembly 150. The first speaker assembly 110 is disposed on the casing 102 and configured to emit a first sound. Similarly, the second speaker assembly 120 is disposed on the casing 102, corresponds to the first sound opening 14, and is configured to emit a second sound, and the second sound is output to the user through the first sound opening 14.

Furthermore, the third speaker assembly 150 is disposed on the casing 102, corresponds to the second sound opening 15, and is configured to emit a third sound, and the third sound is output to the user through the second sound opening 15. The first sound and the second sound are low-frequency sounds, and their frequencies are, for example, 300 Hz to 1000 Hz, and the third sound is a high-frequency sound, and its frequency is, for example, above 1000 Hz, but they are not limited thereto.

As shown in FIG. 5 and FIG. 6, the first speaker assembly 110 and the second speaker assembly 120 are arranged along a first axis AX1 (the Z-axis), and the first speaker assembly 110 is symmetrical to the second speaker assembly 120. Specifically, the speaker module 100 further includes a central base 103, and the first speaker assembly 110 is symmetrical to the second speaker assembly 120 relative to the central base 103.

Therefore, the first speaker assembly 110 and the second speaker assembly 120 have the same configuration. Specifically, as shown in FIG. 6, the first speaker assembly 110 has a first diaphragm 116, a first magnet MG1, and a first coil CL1, and the second speaker assembly 120 has a second diaphragm 126, a second magnet MG2, and a second coil CL2.

When the first coil CL1 and the second coil CL2 receive current, the first coil CL1 and the first magnet MG1 can generate a driving force to drive the first diaphragm 116 to move, and the second coil CL2 and the second magnet MG2 can generate another driving force to drive the second diaphragm 126 to move. The movement directions of the first diaphragm 116 and the second diaphragm 126 are opposite but the amplitudes are the same.

Based on such a design, when the first speaker assembly 110 and the second speaker assembly 120 emit sound at the same time, the vibrations generated by the first speaker assembly 110 and the second speaker assembly 120 can cancel each other out without generating abnormal sound. The specific detailed configuration of the first speaker assembly 110 and the second speaker assembly 120 can refer to Taiwan Patent Publication No. TWI763515B, so it is not be described herein.

Similar to the first speaker assembly 110 and the second speaker assembly 120, the third speaker assembly 150 also has a similar structure. For example, the third speaker assembly 150 also has a third diaphragm 156 which is configured to emit the aforementioned third sound. The remaining structures are not described in detail.

Furthermore, as shown in FIG. 3 and FIG. 4, the casing 102 may have a first sound outlet 1023, a second sound outlet 1024, and a third sound outlet 1025, which respectively correspond to the first speaker assembly 110, the second speaker assembly 120, and the third speaker assembly 150. When viewed along the first axis AX1, the first sound outlet 1023, the second sound outlet 1024, and the third sound outlet 1025 have a rectangular structure.

It should also be noted that in this embodiment, the top cover 12 does not have any opening for the first speaker assembly 110, so that the first sound emitted by the first speaker assembly 110 is output through the first sound opening 14. However, such a configuration may cause the first sound not being quickly discharged from the housing 11, so that the top cover 12 may generate unnecessary vibrations.

In order to ensure that this vibration can be eliminated, the speaker module 100 may further include a guiding assembly 200 which is configured to guide a portion of the first sound to be output through the second sound opening 15, while the other portion of the first sound is still output through the first sound opening 14. Based on such a configuration, the problem of the top cover 12 generating unnecessary vibrations can be avoided.

Next, the specific structural configuration of the guiding assembly 200 is described. As shown in FIG. 3 and FIG. 4, the guiding assembly 200 is disposed on the casing 102, and the guiding assembly 200 includes a first guiding element 202 and a second guiding element 204 which correspond to the first speaker assembly 110 and the second speaker assembly 120, respectively.

As shown in FIG. 3, when viewed along the first axis AX1, the first guiding element 202 is configured to surround two sides of the first sound outlet 1023, and as shown in FIG. 4, when viewed along the first axis AX1, the second guiding element 204 is configured to surround three sides of the second sound outlet 1024.

Specifically, the casing 102 has a first sub-casing 1021 and a second sub-casing 1022, the second sub-casing 1022 is configured to be fixedly connected to the first sub-casing 1021, and the first guiding element 202 has a first guiding portion 2021 and a second guiding portion 2022 which are disposed on the first sub-casing 1021 and configured to form a first channel TB1 with the first sub-casing 1021 so as to guide a portion of the first sound. That is, the first guiding element 202 and the first sub-casing 1021 together form the first channel TB1.

As shown in FIG. 3, the first guiding portion 2021 may have a first segment 2023 and a second segment 2024, and the second guiding portion 2022 may have a third segment 2025 and a fourth segment 2026. The first segment 2023 and the third segment 2025 extend along a second axis AX2, the fourth segment 2026 extends along a third axis AX3, and the second segment 2024 is not parallel to the second axis AX2 and the third axis AX3. The first axis AX1, the second axis AX2 and the third axis AX3 are perpendicular to each other.

Furthermore, as shown in FIG. 4, the second guiding element 204 is disposed on the second sub-casing 1022 and configured to form a second channel TB2, and the second channel TB2 communicates with the first channel TB1. The second guiding element 204 may have a third guiding portion 2041, and when viewed along the first axis AX1, the third guiding portion 2041 has a U-shaped structure to surround three sides of the second sound outlet 1024.

Furthermore, as shown in FIG. 4, the second guiding element 204 may further have a first side segment 2042 and a second side segment 2043 which extend along the first axis AX1, and the third guiding portion 2041 is connected to the first segment 2023 and the third segment 2025 by the first side segment 2042 and the second side segment 2043. That is, the second channel TB2 may be defined by the first side segment 2042, the second side segment 2043 and the third guiding portion 2041.

Similarly, the guiding assembly 200 may further include a third guiding element 206 which corresponds to the third speaker assembly 150 and is configured to form a third channel TB3, and the third channel TB3 communicates with the first channel TB1. The third guiding element 206 may have a fourth guiding portion 2061, and when viewed along the first axis AX1, the fourth guiding portion 2061 has a U-shaped structure to surround three sides of the third sound outlet 1025.

Similarly, the third guiding element 206 may further include a third side segment 2062 and a fourth side segment 2063 which extend along the first axis AX1, and the fourth guiding portion 2061 is connected to the fourth segment 2026 and the second segment 2024 by the third side segment 2062 and the fourth side segment 2063. That is, the third channel TB3 can be defined by the third side segment 2062, the fourth side segment 2063 and the fourth guiding portion 2061.

Based on the above structural configuration, as shown in FIG. 5 and FIG. 7, when the first speaker assembly 110 emits the first sound, a portion of the first sound is emitted from the first sound outlet 1023, moves leftward in FIG. 5 to pass through the first channel TB1 and the third channel TB3, and then output to the user through the aforementioned second sound opening 15. The other portion of the first sound is emitted from the first sound outlet 1023, moves rightward in FIG. 5 to pass through the second channel TB2, and then output to the user through the first sound opening 14.

Therefore, the energy generated by the first sound does not cause the top cover 12 to generate unnecessary vibrations. It is worth noting that since a portion of the first sound and the third sound are output through the second sound opening 15 at the same time, the sound field heard by the user can be made wider, and a better sound experience can be obtained.

In addition, in some embodiments, as shown in FIG. 3, the guiding assembly 200 may further include a fourth guiding element 208 which is configured to be connected to the first guiding element 202, and the fourth guiding element 208 is configured to cover the first channel TB1 and the first speaker assembly 110.

The shape of the fourth guiding element 208 corresponds to the shape of the first guiding element 202. Based on the configuration of the fourth guiding element 208, the airtightness of the first channel TB1 can be increased to increase the guiding effect.

It is worth noting that the first guiding element 202, the second guiding element 204, the third guiding element 206 and the fourth guiding element 208 are installed on the casing 102 in a detachable manner, and can be made of sponge or a rubber material, but they are not limited thereto. The first guiding element 202, the second guiding element 204 and the third guiding element 206 can be integrally formed as one piece.

In addition, in some embodiments, the fourth guiding element 208 may also be made of plastic material, and the fourth guiding element 208 may be integrally formed with the top cover 12. Similarly, the first guiding element 202, the second guiding element 204 and the third guiding element 206 may also be made of plastic material, and the casing 102, the first guiding element 202, the second guiding element 204 and the third guiding element 206 may also be integrally formed as one piece.

In addition, in other embodiments, the first guiding element 202 and the top cover 12 may also be integrally formed as one piece. Based on the above design, the steps in the process can be reduced, and the problem of errors caused by manual installation affecting the sound guiding effect can be avoided.

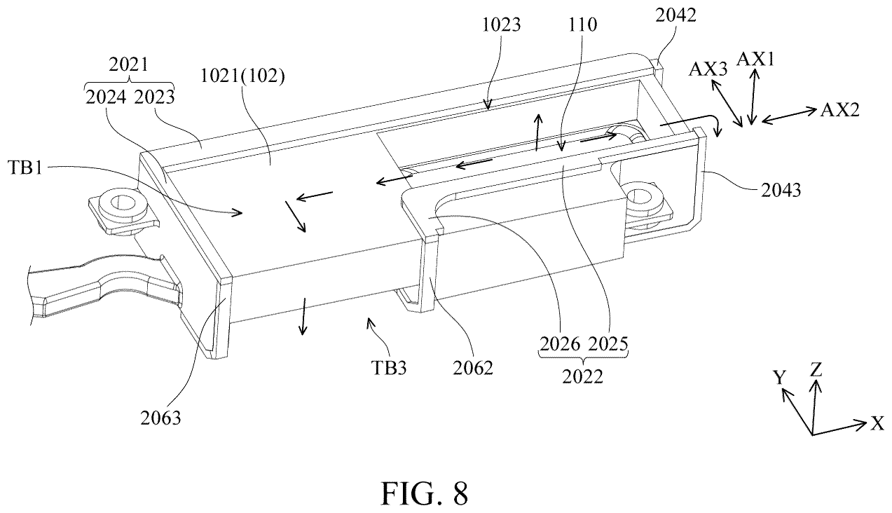

Please refer to FIG. 8. FIG. 8 is a stereoscopic diagram of the speaker module 100 according to another embodiment of the present disclosure. Similar to the aforementioned embodiment, the first guiding portion 2021 of this embodiment may have a first segment 2023 and a second segment 2024, the second guiding portion 2022 may have a third segment 2025 and a fourth segment 2026, and the first segment 2023 and the third segment 2025 extend along the second axis AX2.

Different from the aforementioned embodiment, the fourth segment 2026 and the second segment 2024 of this embodiment both extend along the third axis AX3. Based on such a configuration, the first channel TB1 may have a larger channel width to increase the guiding effect, thereby achieving a better sound output effect.

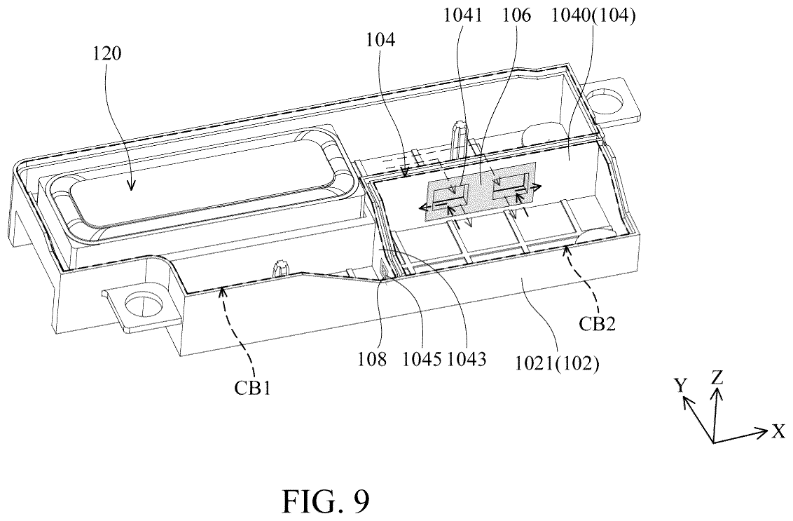

Next, please refer to FIG. 9. FIG. 9 is a stereoscopic diagram of a partial structure of the speaker module 100 according to an embodiment of the present disclosure. As shown in FIG. 9, in this embodiment, the speaker module 100 may further include a separating inner wall 104 which is configured to separate the casing 102 into a first sound cavity CB1 and a second sound cavity CB2. The first sound cavity CB1 corresponds to the first speaker assembly 110 and the second speaker assembly 120, and the second sound cavity CB2 corresponds to the third speaker assembly 150.

The separating inner wall 104 may be formed with at least one first opening 1041, and the speaker module 100 may further include a first one-way air venting element 106 which is disposed on the separating inner wall 104 and covers the first opening 1041. Specifically, in this embodiment, two first openings 1041 are formed on a first wall 1040 of the separating inner wall 104, and the first one-way air venting element 106 covers the two first openings 1041.

The first one-way air venting element 106 can be used as a one-way air valve, allowing an airflow from the first sound cavity CB1 to pass through the first one-way air venting element 106 and enter the second sound cavity CB2, and the first one-way air venting element 106 blocks another airflow from the second sound cavity CB2 to pass through the first one-way air venting element 106 and enter the first sound cavity CB1.

Based on such a configuration, the volume of the cavity provided to the first speaker assembly 110 and the second speaker assembly 120 can be increased. For example, the volume of the first sound cavity CB1 is, for example, 6 cc, and the volume of the second sound cavity CB2 is, for example, 2 cc, so that the total volume provided to the first speaker assembly 110 and the second speaker assembly 120 can reach 8 cc, but the volume provided to the third speaker assembly 150 does not increase.

Therefore, such a configuration can improve the overall low frequency sound output effect, and does not affect the high frequency sound output effect of the third speaker assembly 150. In addition, such a design can also effectively utilize space, so that the speaker module 100 can achieve the purpose of reducing the overall volume.

In addition, the total area of the two first openings 1041 is 40% to 50% of the total area of the first wall 1040 of the separating inner wall 104. Based on such a configuration, it can be ensured that the first one-way air venting element 106 does not separate from the first wall 1040 due to excessive airflow from the first sound cavity CB1.

Furthermore, it should be noted that for the sake of clarity, the second sub-casing 1022 is not shown in the figures, but in fact, when the first sub-casing 1021 is combined with the second sub-casing 1022 and the first opening 1041 is not provided, the first sound cavity CB1 and the second sound cavity CB2 are separated by the separating inner wall 104 and are not in communication with each other.

In addition, the separating inner wall 104 may further include a second wall 1043, a second opening 1045 is formed on the second wall 1043, and the speaker module 100 may further include a second one-way air venting element 108 which is disposed on the second wall 1043 and covers the second opening 1045.

It should be noted that the area of the second opening 1045 on the second wall 1043 is also 40% to 50% of the total area of the second wall 1043. In addition, in other embodiments, the second opening 1045 and the second one-way air venting element 108 may be omitted.

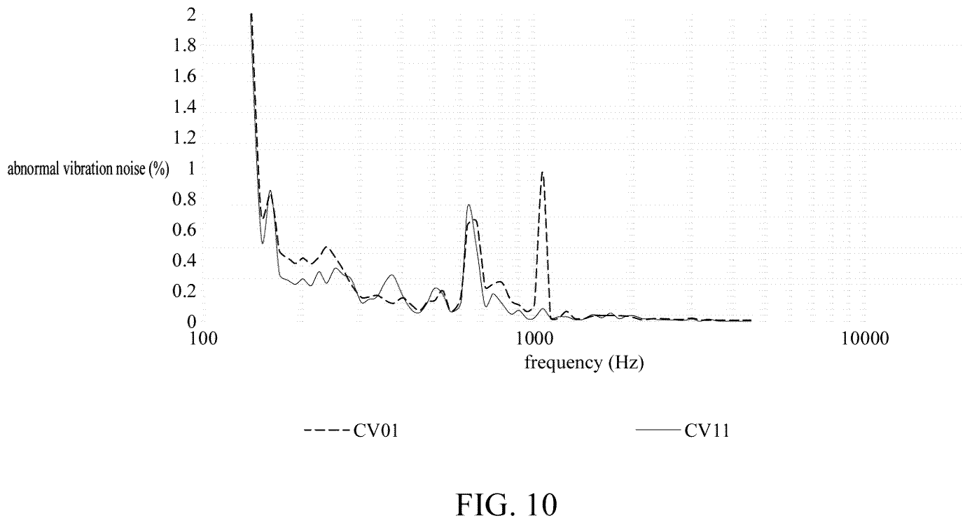

Please refer to FIG. 10. FIG. 10 shows the relationship diagram between the abnormal noise and the frequency of the speaker module 100 according to an embodiment of the present disclosure and a conventional speaker without the guiding assembly 200. In FIG. 10, the curve CV01 represents the abnormal sound analysis curve of the conventional speaker module at different frequencies, and the curve CV11 represents the abnormal sound analysis curve of the speaker module 100 at different frequencies.

As shown in FIG. 10, when the frequency is about 1000 Hz, the data of the curve CV01 reaches 1 (100%), that is, at this frequency, the user can clearly hear that the portable electronic device 10 generates abnormal sound.

As for the curve CV11, when the frequency is about 1000 Hz, the data of abnormal vibration noise of the curve CV11 is about 0.1, which is significantly lower than that of the curve CV01, so that the user does not hear the abnormal sound. In the abnormal sound analysis, when the data does not reach 1, the user does not hear the abnormal sound, and when the frequency is below 300 Hz, the sound when the data reaches 1 is not audible to the human ear, so it does not affect the user's experience.

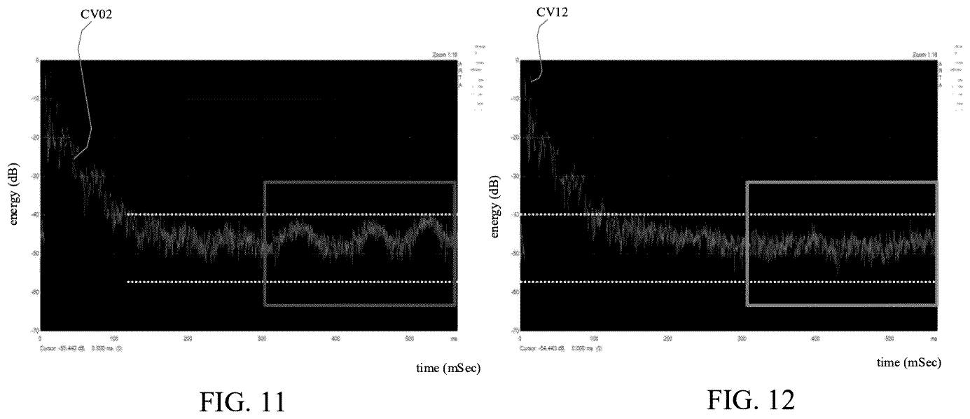

Next, please refer to FIG. 11 and FIG. 12. FIG. 11 is an energy analysis curve diagram of a conventional speaker module, and FIG. 12 is an energy analysis curve diagram of the speaker module 100 according to an embodiment of the present disclosure. In FIG. 11 and FIG. 12, the curve CV02 represents the energy analysis curve of the conventional speaker module relative to time, and the curve CV12 represents the energy analysis curve of the speaker module 100 relative to time.

When time is 0, the conventional speaker module and the speaker module 100 receive a test signal (such as a square wave signal or a pulse signal). As shown in FIG. 11, after receiving the signal, for example, between 300 milliseconds and 600 milliseconds (in the red frame in FIG. 11), the curve CV02 still has obvious up and down oscillations.

In contrast, as shown in FIG. 12, after receiving the signal, between 300 milliseconds and 600 milliseconds (in the blue frame in FIG. 12), the curve CV12 has significantly stabilized, exhibiting no obvious up and down oscillations. That is, the speaker module 100 with the guiding assembly 200 can effectively dissipate the energy generated by the sound signal quickly, so that no abnormal sound is generated.

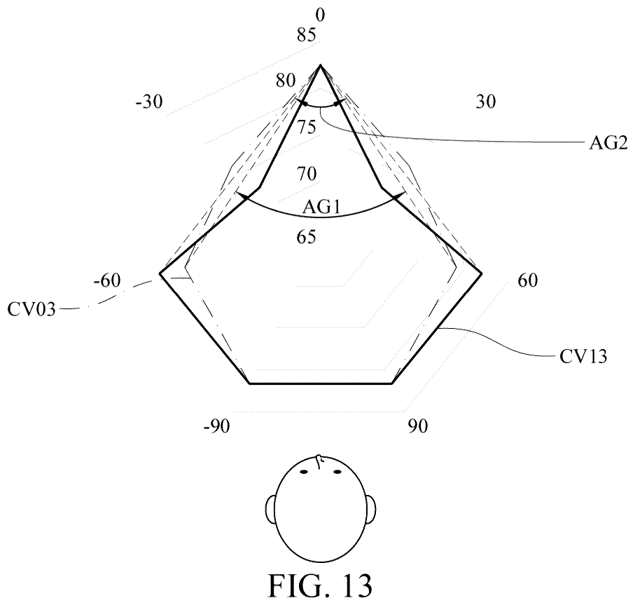

Next, please refer to FIG. 13. FIG. 13 is a sound field analysis diagram of the speaker module 100 according to an embodiment of the present disclosure and a conventional speaker module. In FIG. 13, the fold line CV03 represents the sound field analysis diagram of the conventional speaker module, and the fold line CV13 represents the sound field analysis diagram of the speaker module 100.

The portable electronic device 10 is placed at the coordinate 0 position. As shown in FIG. 13, the maximum sound field angle AG2 of the fold line CV13 relative to coordinate 0 is greater than the maximum sound field angle AG1 of the fold line CV03 relative to coordinate 0. That is, after adding the guiding assembly 200, the sound field of the sound emitted by the speaker module 100 can be wider, achieving a better user experience.

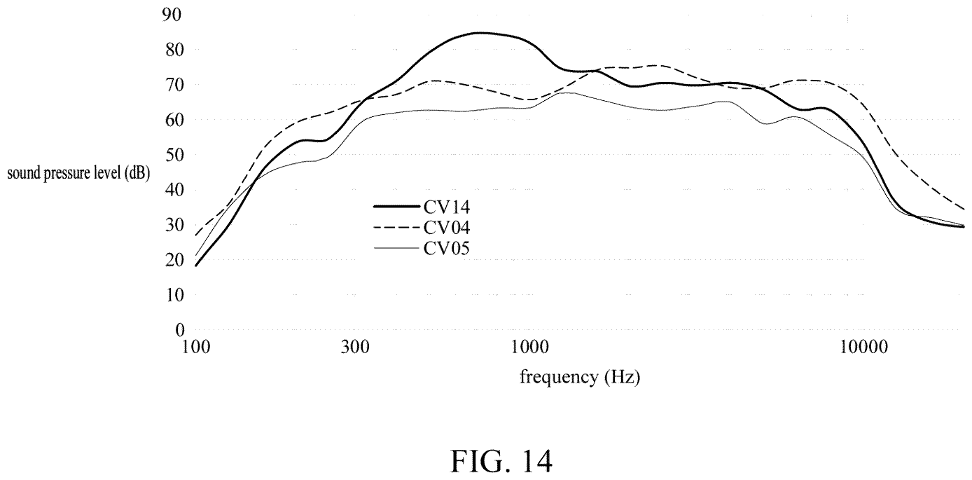

Next, please refer to FIG. 14. FIG. 14 shows a relationship diagram between frequency and sound pressure level of the speaker module 100 according to an embodiment of the present disclosure and two conventional speaker modules. In FIG. 14, the curve CV04 and the curve CV05 represent the sound pressure level curves of the two conventional speaker modules at different frequencies, and the curve CV14 represents the sound pressure level curve of the speaker module 100 of the present disclosure at different frequencies.

As shown in FIG. 14, when the frequency is above 300 Hz, the maximum sound pressure level (SPL) of the curve CV14 is 89.4 dB, the maximum sound pressure level of the curve CV04 is 82.9 dB, and the maximum sound pressure level of the curve CV05 is 75 dB. That is, the maximum sound pressure level of the speaker module 100 of the present disclosure is significantly increased, so that a better sound output effect can be achieved.

In conclusion, the present disclosure provides a speaker module 100, which is disposed in a portable electronic device 10. The speaker module 100 includes a first speaker assembly 110, a second speaker assembly 120, and a third speaker assembly 150, and the housing 11 of the portable electronic device 10 has a first sound opening 14 and a second sound opening 15. The first speaker assembly 110 faces the top cover 12 of the housing 11, the second speaker assembly 120 faces the first sound opening 14, and the third speaker assembly 150 faces the second sound opening 15.

In the present disclosure, the top cover 12 does not provide any opening for the first speaker assembly 110, so that the speaker module 100 may further include a guiding assembly 200 which is configured to guide a portion of the first sound emitted by the first speaker assembly 110 to be output through the second sound opening 15, and the other portion of the first sound is still output through the first sound opening 14. Based on such a configuration, the problem of unnecessary vibration generated by the top cover 12 can be avoided.

In addition, the speaker module 100 may further include a separating inner wall 104 which is configured to separate the casing 102 into a first sound cavity CB1 and a second sound cavity CB2. The separating inner wall 104 may form at least one first opening 1041, and the speaker module 100 may further include a first one-way air venting element 106 which is disposed on the separating inner wall 104 and covers the first opening 1041. Based on such a configuration, the volume of the cavity provided to the first speaker assembly 110 and the second speaker assembly 120 can be increased, thereby improving the overall low frequency sound output effect.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A speaker module, comprising:
a casing, disposed in a housing of a portable electronic device, wherein the housing has a first sound opening and a second sound opening;
a first speaker assembly, disposed on the casing and configured to emit a first sound;
a second speaker assembly disposed on the casing, corresponding to the first sound opening and configured to emit a second sound;
a third speaker assembly, disposed on the casing, corresponding to the second sound opening and configured to emit a third sound; and
a guiding assembly, disposed on the casing;
wherein the first speaker assembly is symmetrical to the second speaker assembly, and the guiding assembly is configured to guide a portion of the first sound to the second sound opening.

2. The speaker module as claimed in claim 1, wherein the first speaker assembly and the second speaker assembly are arranged along a first axis, and the casing has a first sound outlet and a second sound outlet, respectively corresponding to the first speaker assembly and the second speaker assembly, wherein when viewed along the first axis, the first sound outlet and the second sound outlet have a rectangular structure.

3. The speaker module as claimed in claim 2, wherein the guiding assembly has a first guiding element and a second guiding element, when viewed along the first axis, the first guiding element is configured to surround two sides of the first sound outlet, and when viewed along the first axis, the second guiding element is configured to surround three sides of the second sound outlet.

4. The speaker module as claimed in claim 3, wherein the casing has a first sub-casing and a second sub-casing, the second sub-casing is configured to be fixedly connected to the first sub-casing, and the first guiding element has a first guiding portion and a second guiding portion which are disposed on the first sub-casing and configured to form a first channel with the first sub-casing.

5. The speaker module as claimed in claim 4, wherein the first guiding portion has a first segment and a second segment, the second guiding portion has a third segment and a fourth segment, the first segment and the third segment extend along a second axis, and the second segment and the fourth segment extend along a third axis, wherein the first axis, the second axis and the third axis are perpendicular to each other.

6. The speaker module as claimed in claim 4, wherein the first guiding portion has a first segment and a second segment, the second guiding portion has a third segment and a fourth segment, the first segment and the third segment extend along a second axis, the fourth segment extends along a third axis, and the second segment is not parallel to the second axis and the third axis, wherein the first axis, the second axis and the third axis are perpendicular to each other.

7. The speaker module as claimed in claim 6, wherein the second guiding element is configured to form a second channel which communicates with the first channel, the second guiding element has a third guiding portion, and when viewed along the first axis, the third guiding portion has a U-shaped structure.

8. The speaker module as claimed in claim 7, wherein the second guiding element further includes a first side segment and a second side segment which extend along the first axis, and the third guiding portion is connected to the first segment and the third segment by the first side segment and the second side segment.

9. The speaker module as claimed in claim 8, wherein the guiding assembly further includes a third guiding element configured to form a third channel which communicates with the first channel, the third guiding element includes a fourth guiding portion, and when viewed along the first axis, the fourth guiding portion has a U-shaped structure.

10. The speaker module as claimed in claim 9, wherein the third guiding element further includes a third side segment and a fourth side segment which extend along the first axis, and the fourth guiding portion is connected to the fourth segment and the second segment by the third side segment and the fourth side segment.

11. The speaker module as claimed in claim 9, wherein the guiding assembly further includes a fourth guiding element configured to be connected to the first guiding element, and the fourth guiding element is configured to cover the first channel and the first speaker assembly.

12. The speaker module as claimed in claim 9, wherein the first guiding element, the second guiding element, and the third guiding element are integrally formed as one piece.

13. The speaker module as claimed in claim 12, wherein the casing, the first guiding element, the second guiding element, and the third guiding element are integrally formed as one piece.

14. The speaker module as claimed in claim 1, wherein the speaker module further includes a separating inner wall which is configured to separate the casing into a first sound cavity and a second sound cavity, the first sound cavity corresponds to the first speaker assembly and the second speaker assembly, and the second sound cavity corresponds to the third speaker assembly.

15. The speaker module as claimed in claim 14, wherein a first opening is formed on a first wall of the separating inner wall, and the speaker module further includes a first one-way air venting element which is disposed on the separating inner wall and covers the first opening, wherein an area of the first opening is 40% to 50% of a total area of the first wall.

16. The speaker module as claimed in claim 15, wherein the first one-way air venting element allows an airflow from the first sound cavity to pass through the first one-way air venting element to enter the second sound cavity, and the first one-way air venting element blocks another airflow from the second sound cavity to pass through the first one-way air venting element to enter the first sound cavity.

17. The speaker module as claimed in claim 15, wherein the separating inner wall further has a second wall, and a second opening is formed on the second wall, and the speaker module further has a second one-way air venting element which is disposed on the second wall and covers the second opening.

18. A portable electronic device, comprising:
a housing, having a top cover and a bottom cover, wherein the bottom cover is connected to the top cover and has a first sound opening and a second sound opening;
a speaker module, disposed between the top cover and the bottom cover, and the speaker module includes:
a casing;
a first speaker assembly, disposed on the casing and configured to emit a first sound;
a second speaker assembly, disposed on the casing, corresponding to the first sound opening and configured to emit a second sound; and
a third speaker assembly, disposed on the casing, corresponding to the second sound opening and configured to emit a third sound; and
a guiding assembly, disposed on the casing;
wherein the guiding assembly is configured to guide a portion of the first sound to the second sound opening.

19. The portable electronic device as claimed in claim 18, wherein the guiding assembly includes a first guiding element, a second guiding element and a third guiding element which respectively correspond to the first speaker assembly, the second speaker assembly, and the third speaker assembly and which respectively form a first channel, a second channel, and a third channel.

20. The portable electronic device as claimed in claim 19, wherein the second channel communicates with the first channel, and the third channel communicates with the first channel, wherein the first guiding element and the top cover are integrally formed as one piece.
